(19) United States
(12) Patent Application Publication
(10) Pub. No.: US 2024/0217873 A1
(43) Pub. Date: Jul. 4, 2024

(54) METHOD AND INSTALLATION FOR PRODUCING LIME OR DOLIME

(71) Applicant: S.A. Lhoist Recherche et Developpement, Ottignies-Louvain-la-Nueve (BE)

(72) Inventors: Ziad HABIB, Linkebeek (BE); Olivier VAN CANTFORT, Woluwe-Saint Pierre (BE)

(73) Assignee: S.A. Lhoist Recherche et Developpement, Ottignies-Louvain-la-Nueve (BE)

(21) Appl. No.: 18/558,315

(22) PCT Filed: May 10, 2022
(86) PCT No.: PCT/EP2022/062544

§ 371 Date: Oct. 31, 2023

(30) Foreign Application Priority Data
May 10, 2021 (EP) 21173090.8

(51) Int. Cl. C04B 2/12; B01D 53/62; B01D 53/83; B01D 53/96; B01J 20/04; B01J 20/34; C04B 2/10; F27B 1/22; F27D 17/00

(52) U.S. Cl. CPC C04B 2/12; B01D 53/62; B01D 53/83; B01D 53/96; B01J 20/041; B01J 20/3433; B01J 20/3483; C04B 2/102; F27B 1/22; F27D 17/004; B01D 2251/404; B01D 2251/602; B01D 2253/1124; B01D 2257/504; B01D 2258/0233; B01D 2258/0283; F27D 2017/006; F27M 2003/03

(57) ABSTRACT

A method for producing lime or dolime, which includes a calcination step for the calcination of calcareous or dolomitic material which is brought into contact with the first fumes which are obtained by combustion of fuel with an oxidizing gas, a cooling of calcined lime or dolime with discharge and collection thereof and a release of a gaseous effluent containing CO₂. Subsequent processing steps result in the formation of a CaO-based sorbent material with separation between the CaO-based sorbent material and a CO₂-concentrated gas stream which is collected. The recycling of said separated CaO-based sorbent material is recycled into a CO₂ depletion step resulting in the extraction of a valorizable fraction of the CaCO₃—CaO based charge with a compensatory introduction of fresh CaCO₃ in the calcination step.

The present invention relates to a method for producing lime or dolime, as well as to an installation for producing lime or dolime, particularly for carrying out such a method.

Such a method usually comprises a calcination of a downward moving calcareous or dolomitic material having a carbonate content CaCO₃+MgCO₃ higher than 90 wt % in contact with first fumes obtained by combustion of fuel in the presence of an oxidizing gas, a cooling of the downward moving calcined calcareous or dolomitic material with collection from bottom of a main value product under the form of lime or dolime and a release of a gaseous effluent containing CO₂.

Said downward motion may be carried out according to a vertical direction, as for example in the shaft kilns, or according to a sloping direction, as for example in the rotary kilns.

So obtained lime or dolime consists of pure oxide products having a CaO+MgO content higher than 80 wt % with a certain content of impurities depending on the purity of the mother limestone or dolomitic limestone and the ash content of the fuel that is used in the kiln. It is important to note that no additives have to be mandatorily supplied with the raw calcareous or dolomitic material for producing lime or dolime. As a general rule, a marketable lime or dolime should have highly pure oxide content ranging between 98% and 80% by weight. A specific impurity that can be a “killer” for many lime or dolime applications is sulphur. For example, steel, refractory or lime slurry applications require low to very low sulphur content.

During the calcination, the starting calcareous or dolomitic material releases a large volume of CO₂. In addition, to achieve this calcination, it is necessary to reach high temperatures and therefore to proceed with the combustion of fuels, which, in turn, causes a significant release of CO₂. Overall, calcination processes have the disadvantage of actively participating in increasing the greenhouse effect.

Moreover, a classical calcination process has the disadvantage of providing combustion of fuel with air and cooling the calcined product with air. Therefrom results a release at the top of the furnace of a gaseous effluent having a high content of diatomic nitrogen, and a comparatively low content of CO₂ (volume concentration from 20% to 27% on dry gas), which is expensive to capture due to the high presence of nitrogen.

A CO₂ capture method associated to a cement clinker kiln is disclosed in the patent application US 2009/0255444. Such a method consists to thermically treat a raw material comprised of limestone, clay and iron ore for producing clinker. The gaseous effluents coming from the clinker kiln are introduced into a CaO-looping system for concentrating CO₂ in the effluents. Clinker manufacturing accommodates with high ash fuels and raw material containing for example only 75 wt % of limestone. In this document the starting raw material contains limestone mandatorily mixed with high contents of clay and iron ore which are to be excluded from the production of lime or dolime. Moreover a residue is continuously purged from the CaO-looping system, said residue being directly recycled to the main cement clinker kiln. Thus the impurities in this residue are integrated in the final clinker product and must be taken into account in its recipe.

A CO₂ capture method, with a so called “carbonate looping”, is also known in the power production industry using coal (see J. Hilz et al., Long-term pilot testing of the carbonate looping in 1 MWₜₕ scale, Fuel 210 (2017), p. 892-899). A CaO fluidized bed in the carbonate looping system captures CO₂ present in the gaseous effluent of a coal combustor. Continuously fresh CaCO₃ must be introduced in the carbonate looping system as make-up, and a residue is also continuously purged and removed from the loop.

From these prior documents, no information may be obtained about the production of marketable lime or dolime. Moreover they result in the continuous purge and removal of a waste product.

The object of the present invention is to produce lime or dolime of quality while allowing capture of the CO₂ released during the calcination process carried out in a lime or dolime kiln, for use or sequestration, without modification of the kiln and of the process which is implemented therein and without continuous removal of an unusable waste product.

To solve this problem, the method indicated above further comprises
a transfer of said gaseous effluent containing CO₂ to a step of CO₂ depletion wherein said gaseous effluent passes through a sorbent material based on CaO which captures CO₂ and forms, by carbonation, a CaCO₃—CaO based charge,
a separation between the CaCO₃—CaO based charge and the CO₂-depleted gaseous effluent, which is removed,
a step of calcination of the separated CaCO₃—CaO based charge in contact with second fumes obtained by combustion of a fuel chosen from the group consisting of the gaseous fuels and the solid and liquid fuels having a ash content less than 10 wt % and a sulphur content less than 1.5 wt % in the presence of dioxygen and CO₂, as oxidizing gas, with, by decarbonation of CaCO₃, formation of said CaO-based sorbent material and release of CO₂,
a separation between the CaO-based sorbent material resulting from said decarbonation and a CO₂-concentrated gas stream which is comprised of said second combustion fumes and of the CO₂ released during said decarbonation of CaCO₃, and which is collected,
a recycling of said separated CaO-based sorbent material into the CO₂-depletion step of said gaseous effluent, and
a continuous extraction, before the step of calcination of said CaCO₃—CaO based charge, of a fraction thereof, as auxiliary value product, with a compensatory introduction of fresh limestone having a CaCO₃ content of at least 90 wt % into said step of calcination of the separated CaCO₃—CaO based charge.

This method is a closed loop regenerative system for CO₂ capture. During the carbonation, CO₂ from for instance the flue gas of a lime kiln as gaseous effluent is captured by a CaO sorbent and submitted to the following exothermic reaction CaO+CO₂→CaCO₃. So, the CO₂ content of the gaseous effluent is drastically reduced, when released in the atmosphere. According to the invention a CO₂-depleted gaseous effluent means a gas having volume concentrations of CO₂ lower than the concentrations of the gaseous effluent of the kiln, advantageously lower than 10% on dry gas, preferably lower than 5%.

In the step of CO₂ depletion the CaO sorbent may advantageously consist in a fluidized bed or a moving bed.

The obtained circulating CaCO₃—CaO based charge comprises CaCO₃ and residual CaO, which has not captured CO₂. The CaCO₃ of this charge is submitted to the endothermic reaction of calcination CaCO₃+heat→CaO+CO₂. According to the invention the heat necessary for this calcination results from a combustion of fuel poor in impurities in the presence of dioxygen and CO₂, as oxidizing gas. This oxidizing gas may preferably be a mixture of dioxygen and CO₂. In such conditions the combustion has the effect of producing in the gas stream mainly CO₂ with some impurities, optionally present only in the form of traces in the fuel, and oxygen not consumed by fuel combustion. This obviously results in a drastic increase in the CO₂ content of the gas stream collected from the loop. By CO₂-concentrated gas stream, it should be understood according to the invention that said gas stream has a CO₂ content of at least 90%, particularly at least 95% by volume on dry gas. And this gas stream rich in CO₂ becomes usable or sequestrable under favourable conditions, which makes it possible to radically reduce the contribution to the greenhouse effect of the lime or dolime production.

According to the invention, the used dioxygen (also called oxygen hereinafter) is a gas whose oxygen content exceeds 90% by volume, preferably 95%, advantageously 98%. The source of pure dioxygen can, for example, be an air separation unit which separates air into dioxygen and nitrogen, or an installed dioxygen tank.

According to the invention, the fuel of the step of calcination of the separated CaCO₃—CaO based charge is preferably gaseous because such a fuel contains neither ash, nor sulphur. Such a fuel may be for example natural gas, hydrogen, biogas, coke oven gas or gasification gas. A liquid or solid fuel such as for example fuel oil, oil, liquid biofuel, petroleum coke, biomass, lignite, coal, may also be selected insofar the ash content of the fuel is <10%, particularly <7%, preferably <5%, most preferably <1% by weight and the fuel sulphur content is <1.5% by weight, preferably <1%, most preferably of 0.1% by weight. The natural gas is particularly preferred. In the following text, the wording fuel poor in impurities is sometimes used to summarize the fuels appropriate according to the invention.

In the step of calcination of the separated CaCO₃—CaO based charge, this charge may advantageously consist in a fluidized bed or a moving bed.

The CaO-based sorbent material produced during the step of calcination is recycled to the step of CO₂ depletion.

According to the invention the method comprises a continuous extraction of a fraction of said CaCO₃—CaO based charge, before its calcination, and a compensatory introduction of fresh limestone having a CaCO₃ content of at least 90 wt %, preferably 95 wt %, advantageously 98 wt %, into said step of calcination of the separated CaCO₃—CaO based charge.

A particularity of a sorbent regenerative system is that the sorbent, here the CaO, becomes less and less active with an increasing number of looping cycles. This phenomenon results from an increased sintering and poisoning of the sorbent by impurities. Advantageously a CaO sorbent capture efficiency of 30% should be maintained during the step of carbonation in order to obtain continuously a CO₂ capture rate of at least 90 vol % in the gaseous effluent coming from the lime or dolime kiln. In order to keep this stable performance, a certain amount of the CaCO₃—CaO based charge circulating from the carbonation to the calcination is extracted. This extracted circulating charge is called the bleed. For compensation, as above indicated, fresh material in the form of CaCO₃ of a purity higher than 90 wt % is added before or during the calcination of the CaCO₃—CaO based charge. This added amount is called the make-up. According to the invention, the bleed is extracted before the calcination of the CaCO₃—CaO based charge. So the collected product avoids a calcination energy cost for its production.

According to the invention the gaseous effluent submitted to the step of CO₂ depletion, which exits from the lime or dolime kiln, should be conform to the normative environmental requirements and consequently is poor in impurities such as ash and sulphur, and moreover a fuel poor in such impurities is used during the step of calcination of the CaCO₃—CaO based charge. Moreover, as above explained, the limestone of the make-up is also of high purity. Therefrom it results that the extracted fraction called bleed has advantageously a CaCO₃+CaO content of at least 80 wt %, preferably of 90 wt %, particularly of 95 wt %. Said bleed is a pulverulent Ca-based material which may contain little or no ash and little or no sulphur and is of good quality and may consequently be exploited as an auxiliary value product in most of lime markets such as civil engineering, agriculture, waste water treatment, paper manufacturing, sludge treatment . . . . As such a bleed is no waste and may be industrially or commercially exploited. Moreover the amount of extracted bleed can be advantageously significant without penalizing the production of the main and auxiliary value products of the process (lime or dolime and bleed), while allowing to improve the purity content of the obtained bleed and the activity of the sorbent during the carbonation. Preferably, during said continuous extraction, a fraction of less than 15 wt %, preferably of 2 to 10 wt %, of said CaCO₃—CaO based charge is extracted. It results from experimentation that increasing said fraction results in a significant decrease of the impurities in the bleed.

Consequently, according to the invention, in parallel to the production of lime or dolime, there is an additional production of a marketable Ca-product which is not to be removed as in the prior art.

Advantageously, the calcination of said downward moving calcareous or dolomitic material is carried out at a temperature of 750 to 1750° C., preferably 800 to 1350° C., depending on the searched properties of the final product.

According to an embodiment of the invention, the method comprises, during the CO₂-depletion step, maintaining said carbonation at a temperature below 700° C., preferably from 600 to 670° C., in particular of about 650° ° C., by means of a first heat recovery from the transferred gaseous effluent. At a temperature of 700° C. calcination of CaCO₃ may start. Thus, the carbonation is operated just under this temperature to get fast kinetics of carbonation while avoiding the reverse calcination reaction. Consequently, as the carbonation reaction is exothermic, it is necessary to extract heat from the reaction, particularly by means of a heat exchange with an external fluid. A second heat recovery from the CO₂-depleted gaseous effluent is also possible after its removal from the carbonation since the temperature of this effluent is high, particularly of about 650° C.

According to a particular embodiment of the invention, the method comprises carrying out said step of calcination of the separated CaCO₃—CaO based charge at a temperature from 850° C. to 1200° C., preferably from about 880 to 1050° C., more preferably from 900° ° C. to 1000° ° C., and for example around 920° C. or 950° ° C. and a third heat recovery from the collected CO₂-concentrated gas stream. As this calcination is carried out under high CO₂ partial pressure, such temperatures are maintained to accelerate the calcination while still producing a high specific surface CaO appropriate for capturing CO₂.

Said first, second and/or third heat recoveries may consist of a conversion of calories into electrical power or of other heat recovery applications such as drying, district heating . . . .

The method according to the invention may advantageously comprise, for forming said oxidizing gas of said combustion of the calcination step, a step of mixing pure dioxygen with a fraction of the collected CO₂-concentrated gas stream. The combustion of the fuel with pure oxygen would give rise to flame temperatures which are very high for the usual equipment. Also, advantageously, it is planned to introduce CO₂ simultaneously for diluting the oxygen. Advantageously a fraction of the collected gas stream rich in CO₂ is taken and mixed with oxygen. Instead of the usual oxidizing mixture O₂+N₂ of the air, a O₂+CO₂ mixture is thus obtained with the appropriate flame temperature, while producing during the calcination step a gas stream which is increasingly concentrated in CO₂.

The present invention concerns also an installation for the production of lime or dolime, comprising at least one kiln, each of which comprises
a top supply for a calcareous or dolomitic material,
a calcination zone wherein said calcareous or dolomitic material moves downward and is calcined into lime or dolime in contact with first fumes obtained by combustion of fuel in the presence of an oxidizing gas,
a cooling zone for cooling the downward moving calcined lime or dolime,
a bottom discharge for collecting said cooled calcined lime or dolime, as main value product, and
a top exit for a released gaseous effluent containing CO₂.

According to the invention, said installation further comprises
a carbonation reactor containing a sorbent material based on CaO,
means for transferring said gaseous effluent containing CO₂ from said top exit of said at least one kiln to said carbonation reactor, wherein the gaseous effluent is passed through said sorbent material which captures CO₂ and forms by carbonation a CaCO₃—CaO based charge and a CO₂-depleted gaseous effluent,
a first separation device which, at the top of the carbonation reactor, separates said CaCO₃—CaO based charge from the CO₂-depleted gaseous effluent and removes this gaseous effluent,
a calcination reactor which, via a transfer duct, is supplied with said CaCO₃—CaO based charge coming from the first separation device and in which said CaCO₃—CaO based charge comes into contact with second fumes obtained by combustion of a fuel chosen from the group consisting of the gaseous fuels and the solid and liquid fuels having a ash content less than 10 wt % and a sulphur content less than 1.5 wt % in the presence of dioxygen and CO₂, as oxidizing gas, with, by decarbonation of CaCO₃, formation of said CaO-based sorbent material and release of CO₂,
a second separation device which, at the top of the calcination reactor, separates said CaO-based sorbent material resulting from said decarbonation and a CO₂-concentrated gas stream which is formed of said second combustion fumes and of the CO₂ released during said decarbonation of CaCO₃, and removes this CO₂-concentrated gas stream for collection,
a recycling duct through which the CaO-based sorbent material from the second separation device is fed to the carbonation reactor, and
an extraction duct, which is arranged to extract and collect, from said transfer duct, a fraction of said CaCO₃—CaO based charge, as auxiliary value product, a source of compensatory fresh CaCO₃ being provided for supplying the calcination reactor.

In the installation according to the invention, the gaseous effluent containing CO₂ may be generated by one or several kilns which are able to produce lime or dolime. Therein the raw material is supplied at the top of the kiln and the calcined material is discharged at the bottom, after being cooled. Such kilns are for example rotary furnaces, shaft(s) kilns, such as vertical shaft kilns, annular shaft kilns, parallel flow regenerative kilns, and so on, wherein the calcareous or dolomitic material moves downward according to a vertical direction or to a sloping direction.

According to the ash or sulphur content of the gaseous effluent containing CO₂ released at the top exit of said at least one kiln, said means for transferring said gaseous effluent may consist only in a duct connecting said top exit to the carbonation reactor or may additionally comprise appropriate anti-pollution equipment.

The installation comprises any separation device able to separate a particular solid material from a gas, as for example a cyclone.

In the carbonation reactor the sorbent material may advantageously be in the form of a fluidized bed or a moving bed. In the calcination reactor the CaCO₃—CaO based charge may also advantageously be in the form of a fluidized bed or a moving bed.

Preferably the installation may further comprise a first heat exchanger which is arranged within the carbonation reactor to allow recovery by an external fluid of calories released during carbonation. The temperature within the carbonation reactor may so be maintained at a temperature lower than 700° C. At least one second heat exchanger may be arranged to allow a heat recovery by an external fluid from the CO₂-depleted gaseous effluent which is removed from the first separation device. At least one third heat exchanger may be arranged to allow a heat recovery by an external fluid from the CO₂-concentrated gas stream collected from the second separation device. Said external fluid is particularly water which, in said first, second and/or third heat exchangers, passes to the vapor state and may be supplied to steam turbines for producing electricity.

Other details and features of the method and the installation according to the invention may result from the claims.

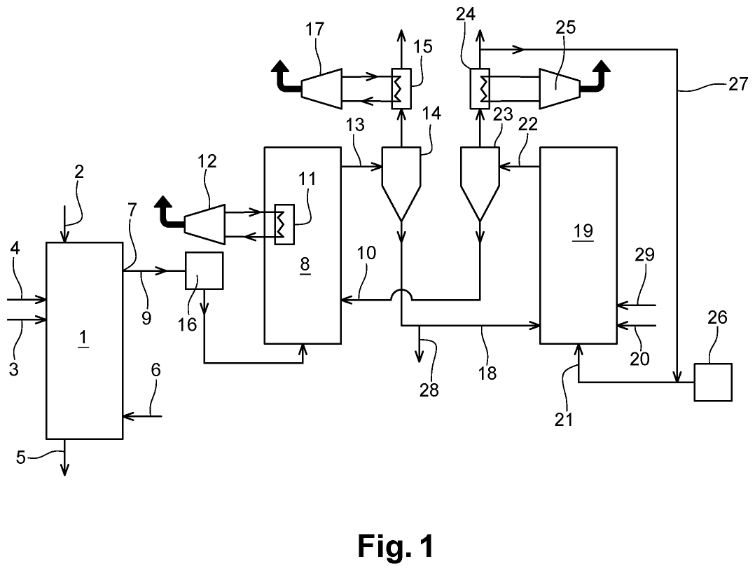

An installation according to the invention is now disclosed by means of FIG. 1 which is a schematic flow sheet of a non-limitative embodiment.

### EXAMPLE 1

The illustrated installation comprises a conventional lime kiln 1, wherein 175 tpd (ton per day) of lime are produced. 12.5 tph (ton per hour) of limestone having a CaCO₃ content of 96 wt % are introduced through the top supply 2 and are calcined into lime in contact with fumes obtained by combustion of 1.6 tph of biomass supplied in 3 in the presence of primary air as carrier gas and of secondary air supplied in 4. 7.3 tph of lime, cooled by a cooling air introduced in 6 and having a CaO content of 93 wt % are discharged through the bottom discharge 5. A gaseous effluent is released from the kiln through the top exit 7 and, by means of the connecting duct 9, is transferred to a carbonation reactor 8 via a purification system 16, which comprises a dust collector, a dryer and/or a desulphurization unit.

TABLE 1
Gaseous effluent which penetrates into the carbonation reactor 8.

Volume: 17 560 Nm³/h
Temperature: 150° C.
CO₂ flow rate: 7.78 tph
CO₂ volume concentration: 24.2% on dry gas
O₂ volume concentration: 10.0% on dry gas
SO₂: 3 ppm
Dust: 10 mg/Nm³

As it results from table 1, the CO₂ volume concentration in the gaseous effluent is very low with respect to the N₂ concentration (65%). In such condition a separation of both components is not easily feasible and would be costly due to the large gas volume to be treated.

The carbonation reactor 8 is provided with a fluidized bed of a sorbent material based on CaO supplied by a recycling duct 10. There 90% of the CO₂ of the gaseous effluent is captured by CaO, which is carbonated into CaCO₃ according to an exothermic reaction. Within the carbonation reactor 8 the temperature of the gaseous effluent must be maintained at a value of about 650° C., under the start of the reverse calcination reaction, by means of a heat exchanger 11 which communicates with a turbine 12 in order to convert heat into electrical power. A power of 2.3 MWe is so obtained.

From the carbonation reactor 8, the gaseous effluent carrying a CaCO₃—CaO based charge is supplied via a transfer duct 13 to a cyclone 14 from the top of which a CO₂-depleted gaseous effluent is released.

TABLE 2
CO₂-depleted gaseous effluent which exits from the cyclone 14.

Volume: 14 015 Nm³/h
Temperature: 650° C.
CO₂ flow rate: 0.8 tph
CO₂ volume concentration: 2.81% on wet gas.

Now the gaseous effluent exiting from the top of the cyclone 14 contains only traces of CO₂ and may be removed in the atmosphere. Before this removal the gas passes through a heat exchanger 15 which communicates with a turbine 17 in order to convert heat into electrical power. A power of 1.5 MWe is so obtained.

The solid particles of the separated CaCO₃—CaO based charge exit from the bottom of the cyclone 14 and are supplied to the bottom of the calcination reactor 19 by means of the transfer duct 18.

The calcination reactor 19 is also supplied with a fuel containing almost no impurities. In the illustrated case 1857 Nm³/h of natural gas (i.e. a fuel containing no ash and no sulphur) are introduced into the calcination reactor 19 via the inlet 20 and 23 tph of an oxidizing gas containing dioxygen and CO₂ are supplied via the introduction duct 21. The calcination reactor is operated at a temperature of about 900° C. in order to accelerate the calcination and produce a high specific surface CaO during the calcination of the CaCO₃—CaO based charge.

From the calcination reactor 19, the gaseous effluent carrying active CaO is supplied via a transfer duct 22 to a cyclone 23 from the top of which a CO₂-concentrated gas stream is collected.

TABLE 3
CO₂-concentrated gas stream which exits from the cyclone 23.

Volume: 19 713 Nm³/h
Temperature: 900° C.
CO₂ flow rate: 29 tph
CO₂ volume concentration: 96% on dry gas

The CO₂ concentration in the gas stream exiting from the cyclone 23 is extremely high. Such a gas may be industrially valorized, for example for technical CO₂ production, or for sequestration. Before collection, the gas stream passes through a heat exchanger 24 which communicates with a turbine 25 in order to convert heat into electrical power. A power of 3.17 MWe is so obtained.

The active CaO-based sorbent material exits separately from the bottom of the cyclone 23 and is recycled to the bottom of the carbonation reactor 8 by means of the recycling duct 10.

Before said combustion of a fuel poor in impurities in the presence of an oxidizing gas containing dioxygen and CO₂, dioxygen is mixed with a fraction of the collected CO₂-concentrated gas stream. 5 tph of oxygen produced at a concentration of 90% by an air separation unit 26 and 18 tph of CO₂-concentrated gas recycled by means of the recirculation duct 27 are mixed and introduced in the calcination reactor 19 by means of the introduction duct 21, as oxidizing gas. Obviously recirculated CO₂-concentrated gas and pure dioxygen may be fed separately to the calcination reactor wherein their mixture takes place in situ.

During the capture of CO₂ in the carbonation reactor 8, there is formation of CaCO₃ as above explained, but CaO of the fluidized bed participates only partially to the carbonation. Consequently, the CaCO₃—CaO based charge which circulates between the carbonation reactor 8 and the calcination reactor 19 contains not only particles of CaCO₃ but also particles of CaO.

TABLE 4
CaCO₃-CaO based charge circulating in the transfer duct 18

| | tph | wt % |
|---|---|---|
| CaCO₃ | 16 | 41 |
| CaO | 21 | 53 |
| Ash | 0 | 0 |
| CaSO₄* | 0 (0.018) | 0 (0.04) |
| Other impurities ** | 2.21 | 5.68 |
| Total | 38.95 | 100 |

*CaSO₄ results from the gaseous effluent of the lime kiln
** Other impurities result mainly from the limestone of the make-up.

CaO becomes less and less active with increasing cycles. There is an increased sintering of the particles. And, in order to keep a CO₂ capture efficacy of at least 30% of active CaO in the CaO-based sorbent material, a bleed flowrate of 0.8 tph of CaCO₃—CaO based charge (2 wt % of the CaCO₃—CaO based charge) is extracted from the transfer duct 18 via the extraction duct 28. For compensation, a make-up of 1.06 tph of fresh limestone having a CaCO₃ content of 96 wt % is introduced into the calcination reactor via the entrance 29. As the fuel used in the calcination reactor 19 does not contain any ash or sulphur and the compensatory limestone of the make-up has a high purity degree, the recycled CaO-based sorbent material is very pure as well as the circulating CaCO₃—CaO based charge which contains only Ca-based components. Consequently the bleed is no waste and may be used in several fields, such as the gas or water epuration, the agriculture, the paper manufacture, the civil engineering, etc.

The captured CO₂ in the gas stream collected from the calcination reactor is summarized in Table 5

TABLE 5

CO₂ captured by CaO in the carbonation reactor: 7 tph
CO₂ resulting from the combustion of the fuel in the
calcination reactor: 3.3 tph
CO₂ resulting from the calcination of the make-up: 0.5 tph
Total: 10.8 tph

Simultaneously the gas stream collected from the calcination reactor is very concentrated in CO₂ and exploitable or sequestrable, the bleed is a valuable Ca product manufactured in parallel to the production of lime or dolime and the need of electricity of the installation, particularly the air separation unit, is satisfied by the production of the turbines.

### EXAMPLE 2

The method according to the invention will now be disclosed in a lime plant comprising several furnaces and producing 2000 tpd of lime, the fuel being lignite. The gaseous effluents of all furnaces are collected together and sent into a carbonator-calcinator system as illustrated on FIG. 1.

TABLE 6
Gaseous effluent which penetrates into the carbonation reactor 8.

Volume: 240 657 Nm³/h
Temperature: 180° C.
CO₂ flow rate: 97 tph
CO₂ volume concentration: 21.3% on dry gas
O₂ volume concentration: 10.0% on dry gas
SO₂: 68 ppm
Dust: 10 mg/Nm³

TABLE 7
CO₂-depleted gaseous effluent which exits from the cyclone 14.

Volume: 196 573 Nm³/h
Temperature: 650° C.
CO₂ flow rate: 10 tph
CO₂ volume concentration: 2.49% on wet gas

TABLE 8
CO₂-concentrated gas stream which exits from the cyclone 23.

Volume: 244 550 Nm³/h
Temperature: 900° C.
CO₂ flow rate: 363 tph
CO₂ volume concentration: 96% on dry gas

66 tph of oxygen produced at a concentration of 90% by the air separation unit 26 and 222 tph of CO₂-concentrated gas recycled by means of the recirculation duct 27 are mixed as oxidizing gas and introduced in the calcination reactor. 23 014 Nm³/h of natural gas (i.e. a fuel without ash or sulphur) are also supplied to this reactor, as fuel.

TABLE 9
CaCO₃-CaO based charge circulating in the transfer duct 18

| | tph | wt % |
|---|---|---|
| CaCO₃ | 198 | 42 |
| CaO | 259 | 54 |
| Ash | 0 | 0 |
| CaSO₄* | 4.86 | 1% |
| Other impurities** | 14 | 2.9 |
| Total | 475 | 100 |

*CaSO₄ results from the gaseous effluent of the lime kilns
**Other impurities result mainly from the limestone of the make-up.

In order to keep a CO₂ capture efficacy of at least 30% of active CaO in the CaO-based sorbent material, a bleed flowrate of 10 tph (2 wt %) of CaCO₃—CaO based charge is extracted from the transfer duct 18 via the extraction duct 28. For compensation, a make-up of 13 tph of fresh limestone having a CaCO₃ content of 98 wt % is introduced into the calcination reactor.

The electrical power produced with the steam turbines is: 30 MWe for the turbine 12, 21 MWe for the turbine 17 and 39 MWe for the turbine 25.

The captured CO₂ in the gas stream collected from the calcination reactor is summarized in Table 10

TABLE 10

CO₂ captured by CaO in the carbonation reactor: 87 tph
CO₂ resulting from the combustion of the fuel in the
calcination reactor: 41 tph
CO₂ resulting from the calcination of the make-up: 6 tph
Total: 134 tph

### EXAMPLE 3

The method according to the invention will now be disclosed in the same lime plant as in Example 2. The gaseous effluents of all furnaces are collected together and sent into a carbonator-calcinator system as illustrated on FIG. 1, but in the calcination reactor the used fuel is a lignite which has an ash content of 3.8 wt % and a sulphur content of 0.4 wt %.

Obviously the gaseous effluent which penetrates into the carbonation reactor 8 and the CO₂-depleted gaseous effluent which exits from the cyclone 14 show the same features as in the tables 6 and respectively 7 of Example 2.

TABLE 11
CO₂-concentrated gas stream which exits from the cyclone 23.

Volume: 235 805 Nm³/h
Temperature: 900° C.
CO₂ flow rate: 402 tph
CO₂ volume concentration: 96% on dry gas

65 tph of oxygen produced at a concentration of 90% by the air separation unit 26 and 220 tph of CO₂-concentrated gas recycled by means of the recirculation duct 27 are mixed as oxidizing gas and introduced in the calcination reactor. 40 tph of the above-mentioned lignite are also supplied to this reactor, as fuel.

TABLE 12
CaCO₃-CaO based charge circulating in the transfer duct 18

| | tph | wt % |
|---|---|---|
| CaCO₃ | 198 | 36 |
| CaO | 259 | 47 |
| Ash | 73 | 13.37 |
| CaSO₄* | 3 | 0.59 |
| Other impurities** | 14 | 2.47 |
| Total | 547 | 100 |

*CaSO₄ results from the gaseous effluent of the lime kilns and from the fuel of the calcination reactor
**Other impurities result mainly from the limestone of the make-up

In order to keep a CO₂ capture efficacy of at least 30% of active CaO in the CaO-based sorbent material, a bleed flowrate of 16 tph (3 wt %) of CaCO₃—CaO based charge is extracted from the transfer duct 18 via the extraction duct 28. For compensation, a make-up of 20 tph of fresh limestone having a CaCO₃ content of 98% is introduced into the calcination reactor. The bleed contains 16 wt % of impurities and is still a valuable product.

The electrical power produced with the steam turbines is: 31 MWe for the turbine 12, 21 MWe for the turbine 17 and 39 MWe for the turbine 25.

The captured CO₂ in the gas stream collected from the calcination reactor is summarized in Table 13.

TABLE 13

CO₂ captured by CaO in the carbonation reactor: 87 tph
CO₂ resulting from the combustion of the fuel in the
calcination reactor: 86 tph
CO₂ resulting from the calcination of the make-up: 9 tph
Total: 182 tph

### EXAMPLE 4

The method according to the invention will now be disclosed in the same lime plant as in Example 2. The gaseous effluents of all furnaces are collected together and sent into a carbonator-calcinator system as illustrated on FIG. 1, but in the calcination reactor the used fuel is the lignite of Example 3.

Obviously the gaseous effluent which penetrates into the carbonation reactor 8 and the CO₂-depleted gaseous effluent which exits from the cyclone 14 show the same features as in the tables 6 and respectively 7 of Example 2.

TABLE 14
CO₂-concentrated gas stream which exits from the cyclone 23.

Volume: 284 892 Nm³/h
Temperature: 900° C.
CO₂ flow rate: 485 tph
CO₂ volume concentration: 96% on dry gas

78 tph of oxygen produced at a concentration of 90% by the air separation unit 26 and 265 tph of CO₂-concentrated gas recycled by means of the recirculation duct 27 are mixed as oxidizing gas and introduced in the calcination reactor. 48 tph of the above-mentioned lignite are also supplied to this reactor, as fuel.

TABLE 15
CaCO₃-CaO based charge circulating in the transfer duct 18

| | tph | wt % |
|---|---|---|
| CaCO₃ | 198 | 40 |
| CaO | 259 | 52 |
| Ash | 27 | 5.34 |
| CaSO₄* | 1 | 0.2 |
| Other impurities** | 13 | 2.71 |
| Total | 498 | 100 |

*CaSO₄ results from the gaseous effluent of the lime kilns and from the fuel of the calcination reactor
**Other impurities result mainly from the limestone of the make-up.

In order to keep a CO₂ capture efficacy of at least 30% of active CaO in the CaO-based sorbent material, a bleed flowrate of 50 tph (10 wt %) of CaCO₃—CaO based charge is extracted from the transfer duct 18 via the extraction duct 28. For compensation, a make-up of 66 tph of fresh limestone having a CaCO₃ content of 98% is introduced into the calcination reactor. The bleed contains 8.25 wt % of impurities and is a valuable product.

The electrical power produced with the steam turbines is: 32 MWe for the turbine 12, 21 MWe for the turbine 17 and 47 MWe for the turbine 25.

The captured CO₂ in the gas stream collected from the calcination reactor is summarized in Table 13.

TABLE 16

CO₂ captured by CaO in the carbonation reactor: 87 tph
CO₂ resulting from the combustion of the fuel in the
calcination reactor: 104 tph
CO₂ resulting from the calcination of the make-up: 29 tph
Total: 220 tph

A comparison between Example 3 and Example 4 shows that increasing extraction of the bleed rate from 3% to 10% of CaCO₃—CaO based charge results in a significant decrease of the bleed impurities (ash+CaSO₄+other impurities) from 16.43% to 8.25%.

Other embodiments and variants of the present invention may be taken into account within the scope of the claims.

For example the heat recovery may be of any type, not only electrical.

In summary, such plants avoid a high participation to the greenhouse effect and the mass flows and power production are at a favourable level making the supply of make-up possible locally from the plant quarry, the bleed highly valuable and the power production profiting to local communities.

1. A method for producing lime or dolime, comprising
a calcination of a downward moving calcareous or dolomitic material having a carbonate content CaCO₃+MgCO₃ higher than 90 wt % in contact with first fumes obtained by combustion of fuel in the presence of an oxidizing gas,
a cooling of the downward moving calcined calcareous or dolomitic material with a collection from bottom of a main value product under the form of lime or dolime and
a release of a gaseous effluent containing CO₂,
characterized in that it further comprises
a transfer of said gaseous effluent containing CO₂ to a step of CO₂ depletion wherein said gaseous effluent passes through a sorbent material based on CaO which captures CO₂ and forms, by carbonation, a CaCO₃—CaO based charge,
a separation between the CaCO₃—CaO based charge and the CO₂-depleted gaseous effluent, which is removed,
a step of calcination of the separated CaCO₃—CaO based charge in contact with second fumes obtained by combustion of a fuel chosen from the group consisting of the gaseous fuels and the solid and liquid fuels having an ash content less than 10 wt % and a sulphur content less than 1.5 wt % in the presence of dioxygen and CO₂, as oxidizing gas, with, by decarbonation of CaCO₃, formation of said CaO-based sorbent material and release of CO₂,
a separation between the CaO-based sorbent material resulting from said decarbonation and a CO₂-concentrated gas stream which is comprised of said second combustion fumes and of the CO₂ released during said decarbonation of CaCO₃, and which is collected,
a recycling of said separated CaO-based sorbent material into the CO₂ depletion step of said gaseous effluent, and
a continuous extraction, before the step of calcination of said CaCO₃—CaO based charge, of a fraction thereof, as auxiliary value product, with a compensatory introduction of fresh limestone having a CaCO₃ content of at least 90 wt % into said step of calcination of the separated CaCO₃—CaO based charge.

2. Method according to claim 1, characterized in that it comprises, during the CO₂ depletion step, maintaining said carbonation at a temperature below 700° ° C. by means of a first heat recovery from the transferred gaseous effluent.

3. Method according to claim 1, comprising a second heat recovery from the removed CO₂-depleted gaseous effluent.

4. Method according to claim 1, characterized in that it comprises carrying out said step of calcination of the separated CaCO₃—CaO based charge at a temperature from 850 to 1200° C. and a third heat recovery from the collected CO₂-concentrated gas stream.

5. Method according to claim 2, characterized in that said first, second and/or third heat recoveries consist of a conversion of calories into electrical power.

6. Method according to claim 1, characterized in that the fuel of said calcination step is selected from the group consisting of natural gas, hydrogen, biogas, coke oven gas, gasification gas, fuel oils, oils, liquid biofuels, petroleum coke, biomass, lignite, and coal.

7. Method according to claim 1, comprising, for forming said oxidizing gas of said combustion of the calcination step, a step of mixing pure dioxygen with a fraction of the collected CO₂-concentrated gas stream.

8. Method according to claim 1, characterized in that, during said continuous extraction, a fraction of less than 15 wt % of said CaCO₃—CaO based charge is extracted.

9. Method according to claim 1, characterized in that said extracted fraction of said CaCO₃—CaO based charge has a CaCO₃+CaO content of at least 80 wt %.

10. Installation for the production of lime or dolime, comprising at least one kiln, each of which comprises
a top supply for a calcareous or dolomitic material,
a calcination zone wherein said calcareous or dolomitic material moves downwards and is calcined into lime or dolime in contact with first fumes obtained by combustion of fuel in the presence of an oxidizing gas,
a cooling zone for cooling the downwards moving calcined lime or dolime,
a bottom discharge for collecting said cooled calcined lime or dolime, as main value product, and
a top exit for a released gaseous effluent containing CO₂,
characterized in that said installation further comprises
a carbonation reactor containing a sorbent material based on CaO,
means for transferring said gaseous effluent containing CO₂ from said top exit of said at least one kiln to said carbonation reactor, wherein the gaseous effluent is passed through said sorbent material which captures CO₂ and forms by carbonation a CaCO₃—CaO based charge and a CO₂-depleted gaseous effluent,
a first separation device which, at the top of the carbonation reactor, separates said CaCO₃—CaO based charge from the CO₂-depleted gaseous effluent and removes this gaseous effluent,
a calcination reactor which, via a transfer duct, is supplied with said CaCO₃—CaO based charge coming from the first separation device and in which said CaCO₃—CaO based charge comes into contact with second fumes obtained by combustion of a fuel chosen from the group consisting of the gaseous fuels and the solid and liquid fuels having an ash content less than 7 wt % and a sulphur content less than 1.5 wt % in the presence of dioxygen and CO₂, as oxidizing gas, with, by decarbonation of CaCO₃, formation of said CaO-based sorbent material and release of CO₂,
a second separation device which, at the top of the calcination reactor, separates said CaO-based sorbent material resulting from said decarbonation and a CO₂-concentrated gas stream which is formed of said second combustion fumes and of the CO₂ released during said decarbonation of CaCO₃, and removes this CO₂-concentrated gas stream for collection,
a recycling duct through which the CaO-based sorbent material from the second separation device is fed to the carbonation reactor, and
an extraction duct, which is arranged to extract and collect, from said transfer duct, a fraction of said CaCO₃—CaO based charge, as auxiliary value product, a source of compensatory fresh CaCO₃ being provided for supplying the calcination reactor.

11. Installation according to claim 10, further comprising at least one first heat exchanger which is arranged within the carbonation reactor to allow recovery by an external fluid of calories released during carbonation.

12. Installation according to claim 10, further comprising at least one second heat exchanger which is arranged to allow a heat recovery by an external fluid from the CO₂-depleted gaseous effluent removed from the first separation device.

13. Installation according to claim 10, further comprising at least one third heat exchanger which is arranged to allow a heat recovery by an external fluid from the CO₂-concentrated gas stream collected from the second separation device.

14. Installation according to claim 11, characterized in that said external fluid is water which, in said first, second and/or third heat exchangers, passes to the vapor state and in that the installation further comprises at least one steam turbine to which this vapor is supplied to produce electricity.

15. Installation according to claim 10, characterized in that said means for transferring said gaseous effluent containing CO₂ from said top exit of said at least one kiln comprise a purification system.

16. (canceled)
